(19) United States
(12) Patent Application Publication
(10) Pub. No.: US 2024/0053492 A1
(43) Pub. Date: Feb. 15, 2024

(54) OPERATION SYSTEM, OPERATION METHOD, AND OPERATION PROGRAM FOR MOBILE BODY

(71) Applicant: Yamaha Hatsudoki Kabushiki Kaisha, Shizuoka (JP)

(72) Inventors: Kenji ISHIYAMA, Shizuoka (JP); Kento KON, Shizuoka (JP); Hitoshi WATANABE, Shizuoka (JP)

(21) Appl. No.: 18/366,623

(22) Filed: Aug. 7, 2023

(30) Foreign Application Priority Data
Aug. 9, 2022 (JP) 2022-127359

(51) Int. Cl. G01S 19/40; G05D 1/00

(52) U.S. Cl. CPC G01S 19/40; G05D 1/0088

(57) ABSTRACT

An ID management unit allocates a first connection ID to a first vehicle in a first period and allocates the first connection ID to a second vehicle in a second period. A correction information acquisition unit connects to a distribution device using the first connection ID and receives correction information for the first vehicle from the distribution device in the first period. The correction information acquisition unit connects to the distribution device using the first connection ID and receives the correction information for the second vehicle from the distribution device in the second period. With the system, it is possible to reduce waste of connection IDs necessary for connection to the distribution device that distributes correction information for realizing high-accuracy positioning.

### CROSS-REFERENCE TO RELATED APPLICATION

The present application claims priority from Japanese application JP 2022-127359 filed on Aug. 9, 2022, the content of which is hereby incorporated by reference into this application.

### BACKGROUND OF THE INVENTION

### 1. Field of the Invention

The present disclosure relates to an operation system, an operation method, and an operation program for managing a mobile body such as an automatic drive vehicle, an unmanned flying object, or a robot.

### 2. Description of the Related Art

In control of a mobile body such as an automatic drive vehicle or an unmanned aircraft, the position of the mobile body is monitored in a control center. In JP 2021-156840 A and JP 2020-067358 A, high-accuracy positioning by an RTK (Real Time Kinematic) scheme is used. According to the RTK scheme, an error is kept within several centimeters. Therefore, position information obtained by the RTK scheme can be used to determine whether movement of a mobile body follows a planned route generated in advance.

In the RTK scheme, a GNSS (Global Navigation Satellite System) signal is received in a reference station, an accurate position of which is specified, and correction information obtained from the GNSS signal is used. The correction information includes, for example, a pseudo distance (a distance from the reference station to a GNSS satellite) calculated from the GNSS signal and carrier wave phase information. The correction information is transmitted from the reference station to a distribution device and transmitted from the distribution device to the mobile body. A reference station close to the position of the mobile body is selected out of a plurality of reference stations installed in the whole country or a specific region. Correction information obtained from the reference station is transmitted to the mobile body via the distribution device. In the mobile body, correction calculation using the correction information is executed and highly accurate position information is calculated.

When the RTK scheme is used, the mobile body connects to the distribution device via a wireless communication network such as an LTE (Long Term Evolution) or a fifth generation (5G) network. In order to receive the correction information, the mobile body connects to the distribution device using an ID given to the mobile body from the distribution device. However, some mobile bodies have periods in which the high-accuracy positioning is not required. For example, there are mobile bodies used only in the daytime and mobile bodies used only at night. If IDs are secured for all of such a plurality of types of mobile bodies, the IDs are wasted. This sometimes causes unnecessary cost for an operator of the mobile bodies.

### SUMMARY OF THE INVENTION

(1) An operation system proposed by the present disclosure is an operation system that receives, from a distribution device, correction information for calculating high-accuracy position information of a mobile body from provisional position information of the mobile body and operates the mobile body using the high-accuracy position information. The operation system includes: an ID management unit configured to allocate, to a plurality of mobile bodies, connection IDs used for connection to the distribution device; and a correction information acquisition unit configured to transmit the provisional position information of the mobile bodies to the distribution device and receive, from the distribution device, the correction information corresponding to a provisional position indicated by the provisional position information. The ID management unit allocates a first connection ID to a first mobile body, which is one of the plurality of mobile bodies, in a first period and allocates the first connection ID to a second mobile body, which is another one of the plurality of mobile bodies, in a second period. The correction information acquisition unit connects to the distribution device using the first connection ID and receives the correction information for the first mobile body from the distribution device in the first period and connects to the distribution device using the first connection ID and receives the correction information for the second mobile body from the distribution device in the second period. With the operation system, it is possible to efficiently use the connection IDs and reduce the number of connection IDs. As a result, it is possible to reduce cost imposed on an operator of the mobile bodies.

(2) In the operation system described in (1), a use of the first mobile body and a use of the second mobile body may be different. Consequently, a period in which the use of the first mobile body is exerted can be represented as “first period” and a period in which the use of the second mobile body is exerted can be represented as “second period”.

(3) In the operation system described in (1) or (2), a drive area permitted to the first mobile body and a drive area permitted to the second mobile body may be different. Time periods in which the mobile bodies are used are often different if the drive areas are different. As a result, it is easy to divide the first period and the second period.

(4) In the operation system described in (1) to (3), the ID management unit may have ID management information that associates mobile body IDs for identifying the plurality of mobile bodies and a plurality of connection IDs, and the ID management unit may associate a first mobile body ID given to the first mobile body with the first connection ID in the first period and associate a second mobile body ID given to the second mobile body with the first connection ID in the second period. Consequently, it is possible to simplify management of the connection IDs.

(5) In the operation system described in (1) to (4), when a predetermined condition is satisfied, the ID management unit may select, from a plurality of connection IDs, connection IDs allocated to the mobile body IDs of the mobile bodies.

(6) In the operation system described in (1) to (5), the ID management unit may refer to drive schedule information indicating a period in which the correction information is used in control of the plurality of mobile bodies and selectively allocate the first connection ID to the first mobile body and the second mobile body. Consequently, it is possible to systematically allocate the connection ID and avoid shortage of connection IDs.

(7) In the operation system described in (1) to (5), the ID management unit may selectively allocate the first connection ID to the first mobile body and the second mobile body based on drive information of the first mobile body and the second mobile body. Consequently, it is possible to increase flexibility of connection ID allocation.

(8) The operation system described in (1) to (7) may include a management device including the ID management unit and the correction information acquisition unit. The correction information acquisition unit may transmit the correction information received from the distribution device to the first mobile body in the first period and transmit the correction information received from the distribution device to the second mobile body in the second period. Consequently, it is possible to simplify processing in vehicles compared with a system in which the vehicles indirectly connect to the distribution device using connection IDs.

(9) The operation system described in (1) to (8) includes a management device including the ID management unit and the correction information acquisition unit, and the management device may further include a monitoring unit configured to receive information representing a drive state of the mobile bodies from each of the plurality of mobile bodies. Consequently, the mobile bodies can share a communication module for monitoring and a communication module for correction information reception. It is possible to achieve a reduction in cost.

(10) In the operation system described in (9), the monitoring unit may manage the second mobile body based on the provisional position information of the second mobile body in the first period and manage the first mobile body based on the provisional position information of the first mobile body in the second period. Consequently, even in a period in which connection IDs are not allocated, it is possible to monitor the positions of the mobile bodies based on approximate positions of the mobile bodies.

(11) In the operation system described in (1) to (10), the first period may be at least a part of a period in which the second mobile body is stopped or a period in which the second mobile body is manually driven, and the second period may be at least a part of a period in which the first mobile body is stopped or a period in which the first mobile body is manually driven.

(12) In the operation system described in (1) to (11), the number of the plurality of connection IDs permitted for the connection to the distribution device may be smaller than the number of the plurality of mobile bodies managed by the operation system. Consequently, it is possible to reduce cost imposed on the operator of the mobile bodies.

(13) In the operation system described in (1) to (12), the plurality of mobile bodies may further include a third mobile body and a fourth mobile body, and the ID management unit may allocate a second connection ID to the third mobile body in the first period and allocate the second connection ID to the fourth mobile body in the second period. Consequently, the plurality of mobile bodies (the first mobile body and the third mobile body) operate in the first period and the plurality of mobile bodies (the second mobile body and the fourth mobile body) operate in the second period as well. Therefore, it is possible to improve convenience of a user.

(14) In the operation system described in (1) to (13), the first period and the second period may be non-overlapping periods. Consequently, it is possible to simplify connection ID allocation processing.

(15) An operation method proposed by the present disclosure is a method of receiving, from a distribution device, correction information for calculating high-accuracy position information of a mobile body from provisional position information of the mobile body and operating the mobile body using the high-accuracy position information. The operation method includes: an ID management step for allocating, to a plurality of mobile bodies, connection IDs used for connection to the distribution device; and a correction information acquisition step for transmitting the provisional position information of the mobile bodies to the distribution device and receiving, from the distribution device, the correction information corresponding to a provisional position indicated by the provisional position information. The ID management step in a first period includes allocating a first connection ID to a first mobile body, and the ID management step in a second period includes allocating the first connection ID to a second mobile body. The correction information acquisition step in the first period includes connecting to the distribution device using the first connection ID and receiving the correction information for the first mobile body from the distribution device. The correction information acquisition step in the second period includes connecting to the distribution device using the first connection ID and receiving the correction information for the second mobile body from the distribution device. With the operation method, it is possible to efficiently use the connection IDs and reduce the number of connection IDs. As a result, it is possible to reduce cost imposed on an operator of the mobile bodies.

(16) A management program proposed by the present disclosure is an operation program for causing a computer to function as a system that receives, from a distribution device, correction information for calculating high-accuracy position information of a mobile body from provisional position information of the mobile body and operates the mobile body using the high-accuracy position information. The operation program causes the computer to function as: an ID management unit configured to allocate, to a plurality of mobile bodies, connection IDs used for connection to the distribution device; and a correction information acquisition unit configured to transmit the provisional position information of the mobile bodies to the distribution device and receive, from the distribution device, the correction information corresponding to a provisional position indicated by the provisional position information. The ID management unit allocates a first connection ID to a first mobile body in a first period and allocates the first connection ID to a second mobile body in a second period. The correction information acquisition unit connects to the distribution device using the first connection ID and receives the correction information for the first mobile body from the distribution device in the first period and connects to the distribution device using the first connection ID and receives the correction information for the second mobile body from the distribution device in the second period. With the management program, it is possible to efficiently use the connection IDs and reduce the number of connection IDs. As a result, it is possible to reduce cost imposed on an operator of the mobile bodies.

### BRIEF DESCRIPTION OF THE DRAWINGS

FIG. 1 is a block diagram showing an example of an operation system;

FIG. 2 is a block diagram showing an example of hardware of an automatic drive vehicle;

FIG. 3 is a block diagram showing an example of hardware of a management device;

FIG. 4 is a block diagram showing functions of a control unit included in the automatic drive vehicle;

FIG. 5 is a block diagram showing functions of the management device;

FIG. 6 is a diagram showing an example of an ID management table;

FIG. 7 is a diagram showing a first example of a drive schedule table;

FIG. 8 is a diagram showing an example of a drive permission area;

FIG. 9 is a sequence chart showing a flow of processing executed in the operation system;

FIG. 10A is a flowchart showing connection ID allocation processing executed in the management device;

FIG. 10B is a flowchart showing processing for ending connection ID allocation executed in the management device;

FIG. 11A is a diagram showing a second example of the drive schedule table;

FIG. 11B is a diagram showing a third example of the drive schedule table;

FIG. 12 is a diagram for explaining an operation system to which a connection ID is allocated based on a drive state;

FIG. 13 is a flowchart showing an example of processing executed in the management device that allocates a connection ID based on a drive state; and

FIG. 14 is a block diagram showing another example of the operation system.

### DETAILED DESCRIPTION OF THE INVENTION

An example of an operation system of a mobile body proposed by the present disclosure is explained below. The present disclosure is to be considered as an exemplification of the invention, and is not intended to limit the invention to the specific embodiments illustrated by the figures or description below. The present invention will now be described by referencing the appended figures representing embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises”, “comprising”, “includes”, “including” and/or “having”, when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of technologies are disclosed. Each of these has individual benefit and each can also be used in conjunction with one or more, or in some cases all, of the other disclosed technologies. Accordingly, for the sake of clarity, this description will refrain from repeating every possible combination of the individual technologies in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

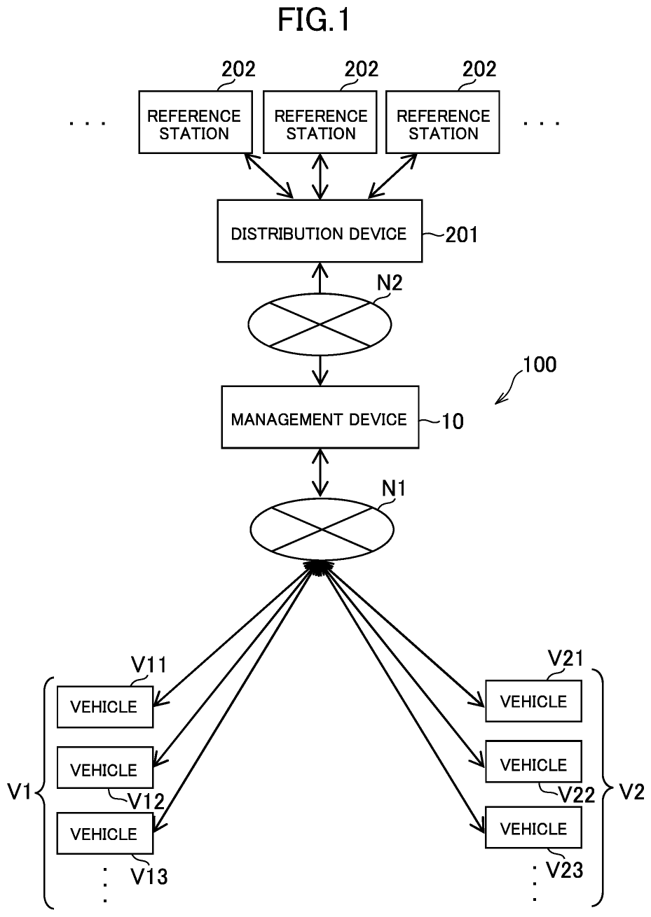

FIG. 1 is a diagram showing an operation system 100, which is an example of the operation system proposed by the present disclosure. In the present disclosure, a mobile body is a device that is moved by a power source such as a motor or an engine. The mobile body is, for example, an automatic drive vehicle. The mobile body may be an unmanned aircraft, a railroad vehicle, a robot, or the like.

[Components of the operation system]

As shown in FIG. 1, the operation system 100 includes a plurality of automatic drive vehicles V11, V12, V13, and the like and a plurality of automatic drive vehicles V21, V22, V23, and the like. In the following explanation, when the vehicles V11, V12, V13, and the like are not distinguished, a reference sign “V1” is used for the vehicles. Similarly, when the vehicles V21, V22, V23, and the like are not distinguished, a reference sign “V2” is used for the vehicles.

A plurality of vehicles V1 and a plurality of vehicles V2 are different in uses. That is, the vehicles V1 and the vehicles V2 are different in time periods in which the vehicles V1 and the vehicles V2 are mainly used. In other words, the vehicles V1 and the vehicles V2 are different in time periods in which high-accuracy positioning is required. The time periods may be specified in advance by, for example, an operator of the vehicles V1 and V2.

The “time period” means, for example, a time period in one day. The vehicles V1 are, for example, vehicles used for human transportation in the daytime or vehicles used in a construction site in the daytime. In contrast, the vehicles V2 are, for example, vehicles used at night or vehicles used to pick up commodities in a warehouse or the like at night.

The “time period” may be a day of week in one week. The vehicles V1 may be, for example, vehicles used for commuting to offices and schools during weekdays. In contrast, the vehicles V2 may be, for example, vehicles used during holidays, in tourist spots or tourist facilities.

The time period may be days in one month or may be months in one year. For example, the vehicles V1 may be vehicles used in the former half of one month and the vehicles V2 may be vehicles used in the latter half of one month. As another example, the vehicles V1 may be vehicles used in summer and the vehicles V2 may be vehicles used in winter.

A drive area permitted to the vehicles V1 and a drive area permitted to the vehicles V2 may be different. For example, the drive permission area for the vehicles V1 may be specified in an urban area of a certain city and, on the other hand, the drive permission area for the vehicles V2 may be specified in a tourist site. Even in this case, the vehicles V1 and V2 of two types are different in time periods in which the vehicles V1 and V2 are mainly used.

As explained in detail below, the plurality of vehicles V1 and the plurality of vehicles V2 connect to, via a management device 10, a distribution device 201 that distributes correction information for performing high-accuracy positioning. The vehicles V1 and the vehicles V2 share a connection ID (identification information) used for connection to the distribution device 201. The connection ID can be shared in this way because a use (a use time period of correction information) of the vehicles V1 and a use (a use time period of correction information) of the vehicles V2 are different.

Note that the operation system 100 may manage vehicles for a third use in addition to the vehicles V1 for a first use and the vehicles V2 for a second use. In this case, vehicles V1, V2, and V3 for the three types of uses (use time periods of correction information) may share an ID.

As shown in FIG. 1, the operation system 100 includes the management device 10. A plurality of vehicles V1 and V2 and the management device 10 are connected via a network N1. The network N1 may include a WAN (Wide Area Network) including the Internet or a dedicated line and a LAN (Local Area Network). These networks include a wired communication network and/or a wireless communication network. A wireless communication technology such as a fourth generation (4G) network or a fifth generation (5G) network may be used for the wireless communication network. Note that the operation system 100 is configured by the management device 10 and the plurality of vehicles V1 and V2. The distribution device 201 and reference stations 202 explained below may not be components of the operation system 100.

The management device 10 is connected to the distribution device 201 via a network N2. Like the network N1, the network N2 may include a WAN including the Internet or a dedicated line and a LAN. The distribution device 201 is connected to a plurality of reference stations 202. The reference stations 202 are installed at fixed points, accurate positions of which are measured in advance. The reference stations 202 acquire, based on GNSS signals received from a not-shown plurality of GNSS satellites, distances from the GNSS satellites to the reference stations 202 (hereinafter referred to as “pseudo distances”) and carrier wave phase information.

The distribution device 201 and the reference stations 202 configure, for example, a GNSS (Global Navigation Satellite System) of an RTK (Real Time Kinematic) scheme. Note that a system configured by the distribution device 201 and the reference stations 202 may configure another GNSS. For example, the distribution device 201 and the reference stations 202 may configure a network-type RTK-GNSS (a VRS scheme or an FKP scheme).

The management device 10 receives correction information from the distribution device 201. The correction information is information for calculating high-accuracy position information of the vehicles V1 and V2 from provisional position information of the vehicles V1 and V2. Correction information is, for example, information for performing RTK correction, in other words, information for performing interference positioning. The correction information is obtained from GNSS signals of a reference station 202 close to a provisional position among the plurality of reference stations 202. The correction information includes pseudo distances from the reference stations 202 to satellites and carrier wave phase information. The correction information may include known accurate position information of the reference stations 202, differences between the pseudo distances and accurate distances, carrier wave phase errors of received GNSS signals, satellite orbit information, clock correction information, troposphere delay correction information, and ionosphere delay correction information.

The provisional position information is position information of the vehicles V1 and V2 required to select and calculate correction information that the distribution device 201 should transmit to the management device 10. The provisional position information is, for example, position information of the vehicles V1 and V2 obtained by independent positioning. As the provisional position information, position information by a differential GPS (relative positioning) may be used. As the differential GPS, for example, a system not requiring connection authentication for reception of correction information such as a satellite-based augmentation system (SBAS) may be used. Note that, in general, a calculation period of position information by the independent positioning based on GNSS signals is shorter compared with a reception period of the correction information. Therefore, as another example of the provisional position information, high-accuracy position information calculated based on the immediately preceding correction information and immediately preceding position information obtained by the independent positioning may be used.

The distribution device 201 distributes correction information corresponding to provisional positions of the vehicles V1 and V2 to the management device 10. For example, when a high-accuracy position of the vehicle V11 is calculated, the distribution device 201 transmits correction information obtained from the reference station 202 close to the provisional position of the vehicle V11 to the management device 10.

### [Hardware of the Automatic Drive Vehicle]

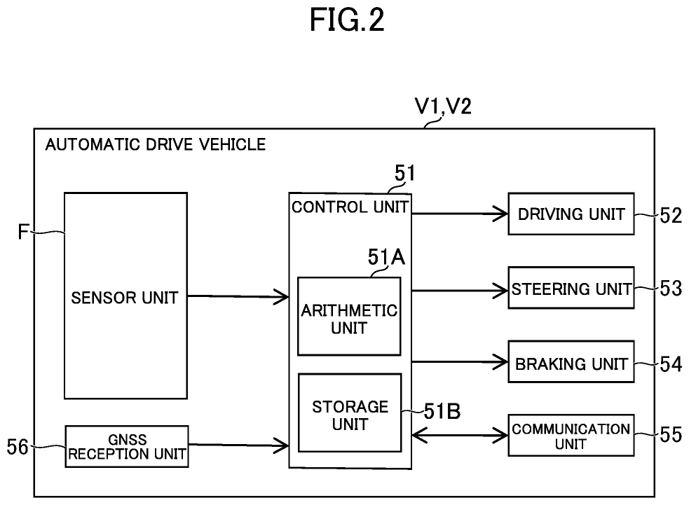

FIG. 2 is a block diagram showing hardware of the automatic drive vehicles V1 and V2. As shown in FIG. 2, each of the vehicles V1 and V2 includes a control unit 51, a driving unit 52, a steering unit 53, a braking unit 54, a communication unit 55, a GNSS reception unit 56, and a sensor unit F. Each of the vehicles V1 and V2 includes the same hardware in FIG. 2 but may also have different kinds of hardware according to their respective uses.

The driving unit 52 includes an electric motor that drives driving wheels of the vehicles V1 and V2, a driving circuit (for example, an inverter circuit) that supplies electric power to the electric motor, and a battery. The driving circuit supplies electric power of the battery to the electric motor according to a command from the control unit 51. A driving source of the vehicles V1 and V2 is not limited to the electric motor and may be an engine.

The steering unit 53 includes a steering device and an actuator (a steering motor) that actuates the steering device. The actuator of the steering unit 53 is controlled by the control unit 51. The braking unit 54 includes a brake device and an actuator that actuates the brake device. The actuator of the brake unit 54 is also controlled by the control unit 51.

The sensor unit F includes a sensor, a device, and a circuit that output signals concerning traveling and a state of a vehicle. The sensor unit F may include, for example, a vehicle speed sensor that outputs a signal corresponding to vehicle speed, an IMU (Inertial Measurement Unit) that outputs a signal corresponding to acceleration and/or angular velocity acting on the vehicles V1 and V2, a circuit that measures an electric current of a battery, a camera that images the peripheries of the vehicles V1 and V2, a LIDAR (Light Detection and Ranging) unit, and a millimeter wave radar. The sensor and the like included in the sensor unit F are not limited to examples explained below.

The control unit 51 includes an arithmetic unit 51A including a CPU (Central Processing Unit) and a storage unit 51B including a RAM (Random Access Memory) and a ROM (Read Only Memory). The arithmetic unit 51A executes a program stored in the storage unit 51B, whereby the control unit 51 controls the vehicles V1 and V2. The control unit 51 controls the driving unit 52, the steering unit 53, and the braking unit 54 such that the vehicles V1 and V2 travel according to, for example, a traveling plan (a traveling route and speed) set by a user of the vehicles V1 and V2 or a traveling plan set by the operator of the vehicles V1 and V2.

The control unit 51 may have an automatic drive mode for controlling the driving unit 52 and the like, according to a traveling plan without requiring operation by an occupant and a manual drive mode for controlling the driving unit 52 and the like, according to operation (e.g. accelerator operation and/or steering operation) by the occupant.

The GNSS reception unit 56 receives GNSS signals from a plurality of GNSS satellites and outputs the GNSS signals to the control unit 51. As explained in detail below, the control unit 51 executes the independent positioning using the GNSS signals and executes high-accuracy positioning using correction information received via the management device 10 (correction calculation performed using the correction information). The control unit 51 may use, as provisional position information, position information by the differential GPS rather than the independent positioning.

The communication unit 55 transmits information concerning traveling and a state of the vehicles V1 and V2 (for example, an output of the sensor unit F, a drive mode, and position information) to the management device 10. In the following explanation, the information concerning traveling and a state of the vehicles V1 and V2 is referred to as “drive information”. The communication unit 55 is, for example, a wireless device that enables bidirectional wireless communication with the management device 10.

### [Hardware of the Management Device]

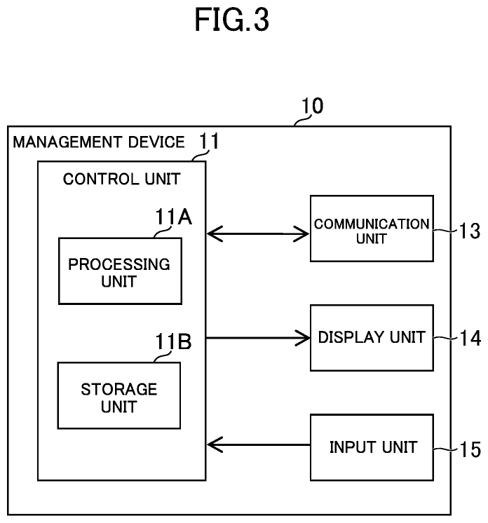

FIG. 3 is a block diagram showing hardware of the management device 10. As shown in FIG. 3, the management device includes a control unit 11 and a communication unit 13. The control unit 11 includes an arithmetic unit 11A and a storage unit 11B.

The arithmetic unit 11A includes a CPU. The storage unit 11B includes a RAM, a ROM, an HDD (Hard Disc Drive), and an SSD (Solid State Drive). The control unit 11 executes, with the arithmetic unit 11A, a program stored in the storage unit 11B and executes processing relating to management of the vehicles V1 and V2. Drive information received from the vehicles V1 and V2 may be stored in the storage unit 11B. The processing executed by the control unit 11 is explained in detail below.

The communication unit 13 is a communication module for performing communication between the vehicles V1 and V2 and the management device 10 and between the distribution device 201 and the management device 10. The communication unit 13 may be a wireless LAN adapter or a wired LAN adapter.

As shown in FIG. 3, the management device 10 may include a display unit 14 and an input unit 15. The display unit 14 is a display that displays drive information of the vehicles V1 and V2 (an output of the sensor unit F) for an administrator of the vehicles V1 and V2. As the input unit 15, for example, a keyboard, a mouse pointer, and a touch sensor provided in the display unit 14, can be used. The input unit 15 receives an instruction input by the administrator.

Note that the management device 10 is implemented by, for example, a server computer but may be implemented by a plurality of computers connected to one another. For example, the management device 10 may include the server computer and a client computer (for example, a personal computer, a smartphone, or a tablet computer) connected to the server computer via a network such as a WAN or a LAN. In this case, the server computer may receive drive information of the vehicles V1 and V2 and transmit the drive information to the client computer. The drive information may be displayed on the display unit 14 connected to the client computer. An instruction of the administrator input through the input unit 15 connected to the client computer may be transmitted to the server computer.

### [Processing Executed in the Automatic Drive Vehicle]

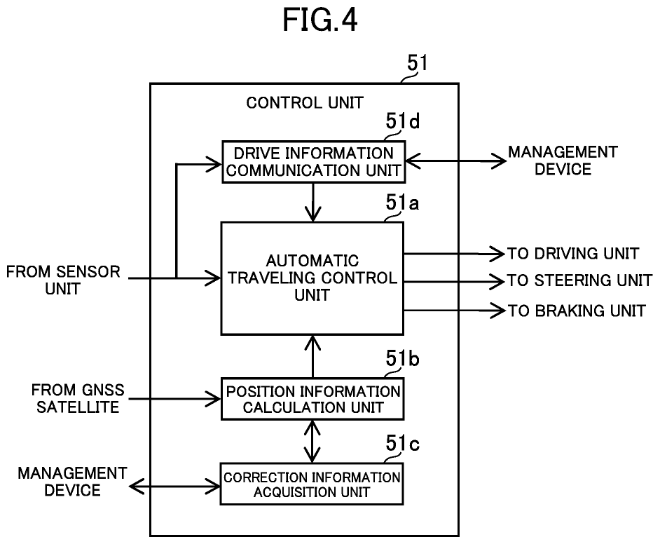

FIG. 4 is a block diagram showing functions included in the control unit 51 of the vehicles V1 and V2. As shown in FIG. 4, the control unit 51 includes, as the functions thereof, an automatic traveling control unit 51a, a position information calculation unit 51b, a correction information acquisition unit 51c, and a drive information communication unit 51d. These functions are realized by the control unit 51 executing a program stored in the storage unit 51B.

### [Automatic Traveling Control Unit]

The automatic traveling control unit 51a controls the driving unit 52, the steering unit 53, and the braking unit 54, based on a signal input from the sensor unit F and a high-accuracy position calculated by the position information calculation unit 51b. The vehicles V1 and V2 receive, for example, a planned route from the management device 10. The automatic traveling control unit 51a controls the driving unit 52, the steering unit 53, and the braking unit 54 such that the vehicles V1 and V2 travel along the planned route.

In the vehicles V1 and V2, a period in which correction information for calculating a high-accuracy position is provided and a period in which the correction information is not provided are set. In the period in which the correction information is not provided, the automatic traveling control unit 51a may not function and manual drive of the vehicles V1 and V2 may be possible. That is, the control unit 51 may receive accelerator operation, steering operation, and brake operation by a driver and control the driving unit 52, the steering unit 53, and the braking unit 54 based on the operation. Unlike this, the automatic traveling control unit 51a may execute automatic drive based on information (for example, an output of the sensor unit F) different from the high-accuracy position information in a period in which the high-accuracy position information by the position information calculation unit 51b is not provided.

In the period in which the correction information is not provided, the control unit 51 may stop the vehicles V1 and V2. For example, when the vehicles V1 and V2 are security vehicles, the control unit 51 may stop the vehicles V1 and V2 in this period and execute guard in a fixed position.

### [Position Information Calculation Unit]

The position information calculation unit 51b calculates high-accuracy position information based on a GNSS signal received by the GNSS reception unit 56 and correction information acquired by the correction information acquisition unit 51c. The position information calculation unit 51b executes, for example, RTK correction calculation based on the GNSS signal and the correction information and calculates the high-accuracy position information as a result of the RTK correction calculation. The position information calculation unit 51b may calculate the high-accuracy position information based on an output of the sensor unit F (for example, outputs of the IMU and the vehicle speed sensor) in addition to the GNSS signal and the correction information.

As explained above, the high-accuracy position is used in the control by the automatic traveling control unit 51a. For example, deviation between high-accuracy present positions of the vehicles V1 and V2 and a planned route is calculated and the driving unit 52 and the like are controlled based on the deviation. An error between the high-accuracy position and an actual position is several centimeters or less.

As explained above, the high-accuracy position information is calculated in the vehicles V1 and V2 rather than the management device 10. Therefore, the control unit 51 can detect the positions of the vehicles V1 and V2 without being delayed behind control of the vehicles V1 and V2.

### [Correction Information Acquisition Unit]

The correction information acquisition unit 51c receives correction information from the distribution device 201 via the management device 10. The position information calculation unit 51b calculates position information (provisional position information) using, for example, a GNSS signal. The correction information acquisition unit 51c transmits the provisional position information to the management device 10 and receives correction information corresponding to a provisional position as a response from the management device 10. The correction information acquisition unit 51c receives the correction information at a predetermined period.

Note that the provisional position information may not always be position information obtained by the independent positioning. As explained above, as the provisional position information, for example, position information by the differential GPS (the relative positioning) may be used. Depending on a reception period for correction information, correction information received during the immediately preceding period may be used for the calculation of the provisional position information.

### [Drive Information Communication Unit]

The drive information communication unit 51d transmits a drive state of the vehicles V1 and V2 to the management device at a predetermined period (for example, several seconds). The management device 10 displays the received drive information on the display unit 14. The drive information communication unit 51d receives a command concerning operation of the vehicles V1 and V2 from the management device 10. The drive information communication unit 51d receives, for example, a stop command. The stop command is transmitted from the management device 10, for example, when the vehicles V1 and V2 travel beyond a drive permission area specified in advance. When receiving the command, the automatic traveling control unit 51a controls the driving unit 52, the steering unit 53, and the braking unit 54 according to the command.

### [Processing Executed by the Management Device]

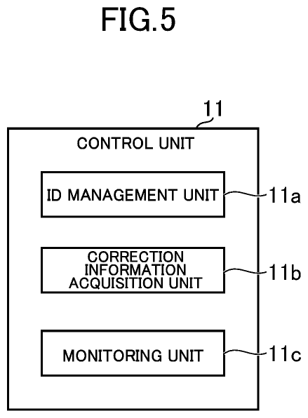

FIG. 5 is a block diagram showing functions included in the control unit 11 of the management device 10. As shown in FIG. 5, the control unit 11 may include, as the functions thereof, an ID management unit 11a, a correction information acquisition unit 11b, and a monitoring unit 11c.

### [ID Management Unit]

The management device 10 connects to the distribution device 201 and receives correction information from the distribution device 201. A connection ID (identification) is necessary to connect to the distribution device 201. That is, when starting the connection to the distribution device 201, the management device 10 transmits the connection ID to the distribution device 201. The distribution device 201 executes authentication processing for the connection ID. When the authentication is successful, processing for transmitting the correction information to the vehicles V1 and V2 is started between the management device 10 and the distribution device 201. On the other hand, when the authentication is unsuccessful, transmission of the correction information from the distribution device 201 is rejected.

The connection ID is issued in advance from, for example, an operator (a company) of the distribution device 201. The management device 10 manages operation of a plurality of vehicles V11, V12, and the like and a plurality of vehicles V21, V22, and the like. If connection IDs are acquired for all of the vehicles V11, V12, and the like and the vehicles V21, V22, and the like managed by the management device 10, connection IDs are necessary by the number of vehicles. This leads to an increase in cost for operators of the management device 10 and the vehicles. For example, when a charge to the operator of the vehicles V1 and V2 and the like from the operator of the distribution device 201 is calculated according to the number of connection IDs, cost is excessively large if connection IDs are secured for all the vehicles V1 and V2.

Therefore, in the operation system 100 proposed by the present disclosure, one connection ID is shared by the plurality of vehicles V1 and V2. For example, the ID management unit 11a allocates a first connection ID (N01) to a first vehicle V11 in a first period (for example, in the daytime) and cancels the allocation of the first connection ID (N01) to the first vehicle V11 and allocates the same first connection ID (N01) to a second vehicle V21 in a second period (for example, at night). Consequently, since the connection ID is effectively used, it is possible to reduce the number of connection IDs and suppress an increase in cost.

The ID management unit 11a performs the same processing for the other vehicles V12, V13, and the like and V21, V23, and the like. For example, the ID management unit 11a allocates a second connection ID (N02) to a third vehicle V12 in the first period and cancels the allocation of the second connection ID (N02) to the third vehicle V12 and allocates the second connection ID (N02) to a fourth vehicle V22 in the second period.

As explained above, the vehicles V11, V12, and the like and the vehicles V21, V22, and the like are different in uses thereof. Therefore, a period (a time period) in which the vehicles V11, V12, and the like are used and a period (a time period) in which the vehicles V21, V22, and the like are used are different. Therefore, a plurality of vehicles can share connection IDs as explained above.

A connection ID is information used for the authentication processing in the distribution device 201 as explained above and is issued from, for example, the operator of the distribution device 201. When the management device 10 and the distribution device 201 communicate via the Internet, information added with identification information (for example, an IP address) of the management device 10 itself and identification information (for example, an IP address) of the distribution device 201 as headers and including a connection ID and position information (or correction information) is transmitted and received between the management device 10 and the distribution device 201.

A vehicle ID is identification information for specifying the individual vehicles V1 and V2 and is given by, for example, the administrator of the vehicles V1 and V2 and stored in the storage unit 51B of the vehicles V1 and V2. When the management device 10 and the vehicles V1 and V2 communicate via the Internet, information added with identification information (for example, an IP address) of the management device 10 itself and identification information (for example, IP addresses) given to the vehicles V1 and V2 as headers and including vehicle IDs and position information (or correction information) may be transmitted and received between the management device 10 and the vehicles V1 and V2.

### [ID Management Information]

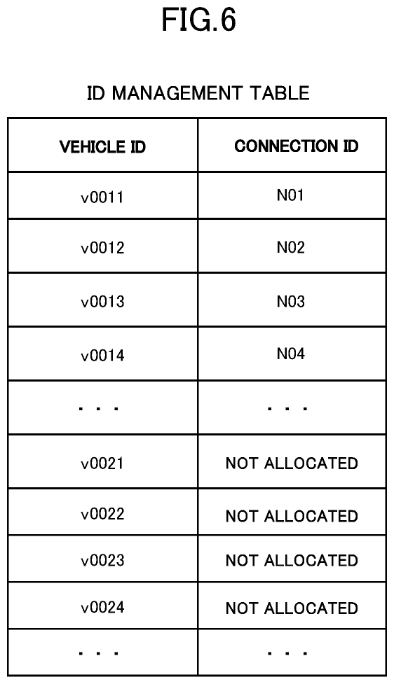

Vehicle IDs for identifying the vehicles V1 and V2 are given to the vehicles V1 and V2. ID management information for associating connection IDs and vehicle IDs may be stored in the storage unit 11B. FIG. 6 is a diagram showing an example of the ID management information. In FIG. 6, a table (an ID management table) is shown as the ID management information. In the example shown in FIG. 6, a plurality of connection IDs (N01, N02, and the like) are associated with vehicle IDs (v0011, v0012, and the like) of the vehicles V11, V12, and the like. On the other hand, connection IDs are not allocated to the vehicles V21, V22, and the like.

For example, when connection IDs are allocated to the vehicles V1 and V2, the ID management unit 11a updates the ID management table. Referring to the example explained above, the ID management unit 11a updates the ID management table when the first period comes and updates the ID management table again when the second period comes. Note that the ID management information does not always have to be the table illustrated in FIG. 6 if the ID management information is information in which connection IDs and vehicle IDs are associated. For example, the ID management information may be a plurality of tables in which vehicle IDs and connection IDs are indirectly linked.

Information (vehicle information) concerning the vehicles V1 and V2 managed by the management device 10 may be stored in the storage unit 11B of the management device 10. In the vehicle information, profiles of vehicles such as car types, performances (for example, battery capacities), and states of the vehicles (for example, out-of-order) may be recorded in association with vehicle IDs. Connection IDs that can be used for connection to the distribution device 201 are recorded in the storage unit 11B. The number of connection IDs that can be used for the connection is smaller than the number of vehicles managed by the management device 10, in other words, the number of vehicles V1 and V2 registered in the vehicle information. In other words, since the connection IDs are shared by the plurality of vehicles V1 and V2, the number of connection IDs can be reduced.

### [Drive Schedule Information]

Allocation of connection IDs to the vehicles V1 and V2 by the ID management unit 11a is executed when a predetermined condition is satisfied. “When a predetermined condition is satisfied” is, for example, when a start time of a period specified in advance (for example, a time period in one day) comes, when a transmission start of correction information is requested from the vehicles V1 and V2, or when the vehicles V1 and V2 start automatic traveling.

The ID management unit 11a may refer to drive schedule information indicating a period in which correction information is used in control of the plurality of vehicles V1 and V2 and allocate connection IDs to the vehicles V1 and V2. In the drive schedule information, a period in which the vehicles V1 and V2 use the correction information is specified. For example, an operator of the operation system 100 can store the drive schedule information in the storage unit 11B in advance through the input unit 15.

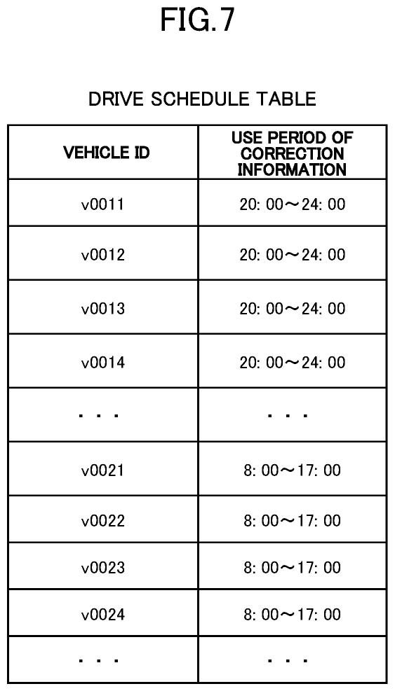

FIG. 7 is a diagram showing an example of the drive schedule information. In FIG. 7, a table (a drive schedule table) is shown as the drive schedule information. In the example shown in FIG. 7, use of correction information at night (20:00 to 24:00 in the example shown in FIG. 7) is permitted to the vehicles V1 (vehicle IDs: v0011 to v0014) and use of correction information in the daytime (8:00 to 17:00 in the example shown in FIG. 7) is permitted to the vehicles V2 (vehicle IDs: v0021 to v0024). In this way, it is desirable that a use period of the correction information specified for the vehicles V1 and a use period of the correction information specified for the vehicles V2 do not overlap.

The ID management unit 11a may periodically refer to the drive schedule table or refer to the drive schedule table according to requests from the vehicles V1 and V2. When the present point in time corresponds to the use period of the correction information, the ID management unit 11a may allocate connection IDs to the vehicles V1 and V2 and update the ID management table illustrated in FIG. 6. On the other hand, when the present point in time does not correspond to the use period of the correction information, the ID management unit 11a may reject allocation of connection IDs to the vehicles V1 and V2 or cancel allocation of connection IDs already given to the vehicles V1 and V2. At this time as well, the ID management unit 11a may update the ID management table illustrated in FIG. 6. The connection IDs are shared between the vehicles V1 and the vehicles V2 according to such processing. On the other hand, since periods in which the plurality of vehicles V1 use the correction information overlap, the connection IDs are not shared among the plurality of vehicles V1. Similarly, since periods in which the plurality of vehicles V2 use the correction information overlap, the connection IDs are not shared among the plurality of vehicles V2.

### [Correction Information Acquisition Unit]

As shown in FIG. 5, the management device 10 includes the correction information acquisition unit 11b as a function thereof. The correction information acquisition unit 11b executes processing relating to reception of correction information.

Specifically, the correction information acquisition unit 11b transmits provisional position information received from the vehicles V1 and V2 to the distribution device 201 at a predetermined period. The correction information acquisition unit 11b receives, as a response from the distribution device 201, correction information corresponding to the provisional position information (correction information obtained from the reference station 202 close to a provisional position) at a predetermined period.

The correction information acquisition unit 11b transmits the received correction information to the vehicles V1 and V2. The control unit 51 of the vehicles V1 and V2 executes calculation of a high-accuracy position based on the correction information (correction calculation). Unlike this, the management device 10 may execute calculation of high-accuracy position information. In this case, the management device 10 transmits high-accuracy position information calculated based on the received correction information to the vehicles V1 and V2. In this case, the management device 10 receives, from the vehicles V1 and V2, information necessary for the correction calculation, specifically, a carrier wave phase obtained from GNSS signals received in the vehicles V1 and V2.

The correction information acquisition unit 11b uses a connection ID in communication with the distribution device 201. For example, the correction information acquisition unit 11b transmits a message (a connection request) for requesting connection establishment to the distribution device 201 together with the connection ID prior to transmission of provisional position information. Then, authentication processing based on the connection ID is executed in the distribution device 201. For example, the distribution device 201 determines whether the connection ID coincides with a regular connection ID issued from the operator of the distribution device 201. The distribution device 201 may determine, based on, for example, whether a payment for the connection ID has been appropriately made, whether to approve the establishment of connection. When the authentication is successful, connection between the management device 10 and the distribution device 201 is established. Thereafter, periodical transmission and reception of provisional position information and correction information between the management device 10 (the correction information acquisition unit lib) and the distribution device 201 is realized. Note that when the connection between the management device 10 and the distribution device 201 is established, the distribution device 201 may issue a session ID for communication by the connection ID for which the authentication is successful and transmit the session ID to the management device 10. After the connection establishment, the session ID may be used for communication between the management device 10 and the distribution device 201.

In the communication between the management device 10 and the distribution device 201, the correction information acquisition unit 11b may refer to ID management information. For example, when receiving provisional position information from the vehicle V11 having the vehicle ID (v0011), the correction information acquisition unit 11b may refer to the ID management table (FIG. 6), which is an example of the ID management information, and transmit the provisional position information to the distribution device 201 using the connection ID (N01) corresponding to the vehicle ID (v0011). At this time, the correction information acquisition unit 11b may transmit the provisional position information to the distribution device 201 using a session ID issued earlier from the distribution device 201. Thereafter, the distribution device 201 may transmit the correction information to the management device 10.

When transmitting the received correction information to the vehicles V1 and V2, the correction information acquisition unit 11b may refer to the ID management information. For example, when receiving correction information for the connection ID (N01), the correction information acquisition unit 11b refers to the ID management table (FIG. 6), which is an example of the ID management information, and transmits the correction information to a vehicle having a vehicle ID corresponding to the connection ID (N01).

Note that, after the communication among the vehicles V1 and V2, the management device 10, and the distribution device 201 is established, the ID management table (FIG. 6) that directly associates the vehicle IDs and the connection IDs may not be referred to. For example, at the time of connection establishment, a session ID used in communication between the vehicles V1 and V2 and the management device 10 and a session ID used in communication between the management device 10 and the distribution device 201 may be linked in the management device 10.

The functions explained above of the correction information acquisition unit 11b are realized by functions of the distribution device 201 explained below. That is, the distribution device 201 receives correction information from the plurality of reference stations 202 and stores the correction information in a storage device included in the distribution device 201. When receiving a transmission request for correction information (a request for connection establishment) from the management device 10, the distribution device 201 executes authentication processing based on a connection ID received together with the request. When the authentication is successful, the distribution device 201 receives provisional position information from the management device 10 and transmits correction information obtained from the reference station 202 close to a provisional position to the management device 10.

### [Monitoring Unit]

As shown in FIG. 5, the management device 10 may include the monitoring unit 11c. The monitoring unit 11c receives drive information (for example, vehicle speed and battery residual power) from the vehicles V1 and V2. The monitoring unit 11c displays the drive information on the display unit 14. The monitoring unit 11c transmits a command input from the input unit 15 by operation of the administrator to the vehicles V1 and V2. The command input from the input unit 15 is, for example, a stop command or a traveling start command.

The monitoring unit 11c may determine, based on vehicle drive information received from the vehicles V1 and V2, whether a drive state of the vehicles V1 and V2 matches a predetermined condition. For example, the monitoring unit 11c may determine whether present positions of the vehicles V1 and V2 are within a drive permission area or determine whether battery temperature is within a range specified in advance. When the drive state of the vehicles V1 and V2 does not match a predetermined condition, the monitoring unit 11c may transmit a command (for example, a stop command) corresponding to a state of the vehicles V1 and V2 to the vehicles V1 and V2.

In the operation system 100, the management device 10 performs monitoring of a drive state of the vehicles V1 and V2 and relay of communication between the vehicles V1 and V2 and the distribution device 201. Consequently, a communication module can be shared for reception of correction information and monitoring of a drive state of the vehicles V1 and V2. It is possible to reduce the number of communication modules loaded on the vehicles V1 and V2.

Manual drive may be permitted to the vehicles V1 and V2 in a period in which use of correction information is not specified in the drive schedule table illustrated in FIG. 6. In this period, the monitoring unit 11c may receive, from the vehicles V1 and V2, position information obtained by the independent positioning or the differential GPS and drive information.

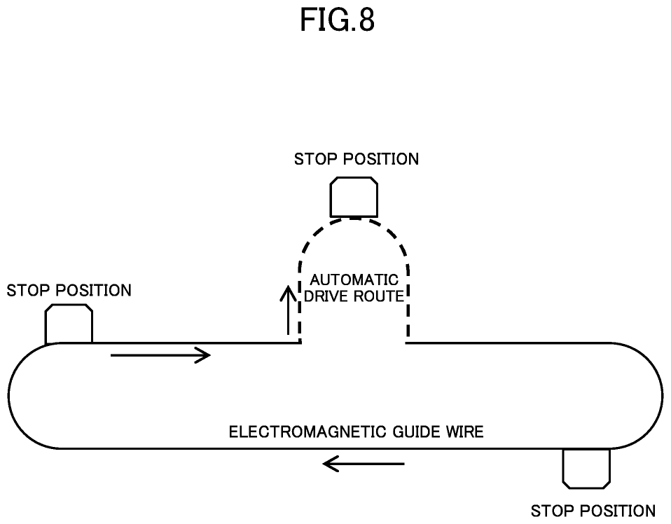

FIG. 8 is a diagram showing an example of a vehicle drive permission area. In the drive permission area, a route on which an electromagnetic guide wire is laid (a solid line route in FIG. 8) is specified. One or a plurality of stop positions may be specified in the route specified by the electromagnetic guide wire. In the drive permission area, a route deviating from the electromagnetic guide wire (a broken line route in FIG. 8; hereinafter referred to as “automatic drive route” as well) is also specified. Stop positions may be specified in the automatic drive route as well.

The vehicle V1 disposed in such a drive permission area may include, in addition to the hardware shown in FIG. 2, a sensor that detects the position of the electromagnetic guide wire. In the route of the electromagnetic guide wire, the control unit 51 controls the driving unit 52 and the like such that a vehicle travels along the guide wire. When the vehicle V1 travels on the automatic drive route (the broken line route), for example, at night, the control unit 51 acquires high-accuracy position information using correction information and executes automatic drive based on the high-accuracy position information and an output of the sensor F. In this period, the monitoring unit 11c may receive drive information (vehicle speed, battery residual power, and the like) of the vehicle V1 and provisional position information from the vehicle V1 and monitor the vehicle V1. In another period (for example, in the daytime), the vehicle V1 may travel on the same route according to manual drive. In this case, the monitoring unit 11c may receive, from the vehicle V1, drive information of the vehicle V1 and position information obtained by the independent positioning or the differential GPS and monitor the vehicle V1 based on the information.

### [Sequence of Processing]

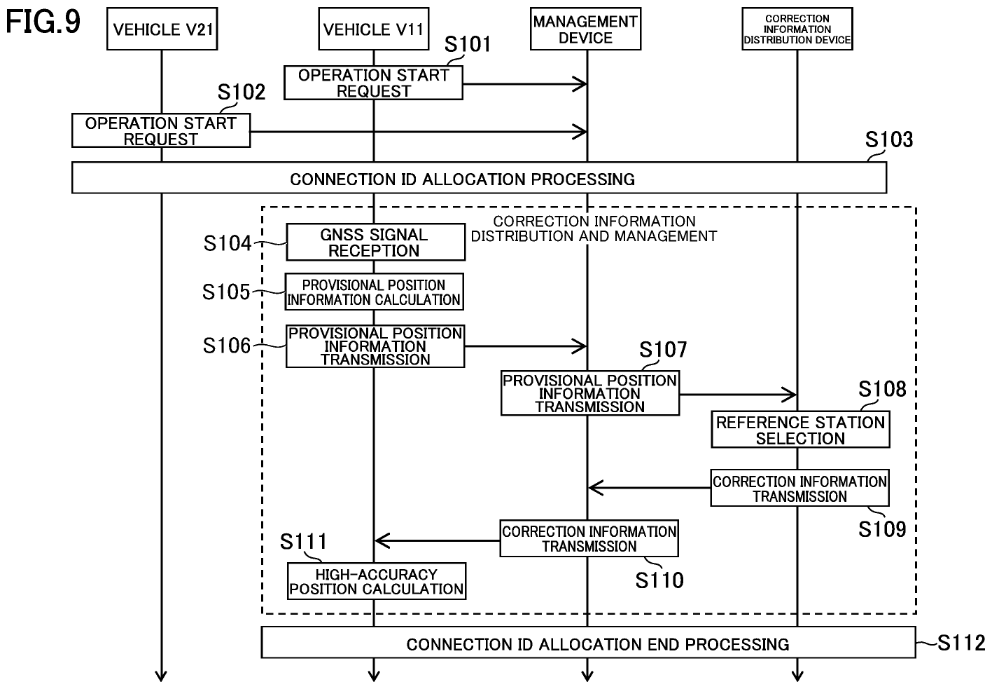

A flow of processing executed in the operation system 100 is explained with reference to FIG. 9. Here, processing in a period in which a connection ID is given to the vehicle V11 of two vehicles V11 and V21 used in different uses and a connection ID is not given to the vehicle V21 is explained as an example.

The vehicle V11 and the vehicle V21 respectively transmit operation start requests to the management device 10 (S101 and S102). The operation start requests may be transmitted when the control unit 51 of the vehicles V11 and V21 is turned on or when a predetermined command is input to the control unit 51. The vehicle V11 and the vehicle V21 transmit vehicle IDs thereof to the management device 10 together with the operation start requests.

In the operation system 100, when the management device 10 receives the operation start requests, processing for connection ID allocation is executed (S103). The connection ID allocation processing is explained in detail below. In the example explained here, the connection ID (N01) is allocated to the vehicle V11 and a connection ID is not allocated to the vehicle V21.

When the connection ID is allocated to the vehicle V11, transmission and reception of provisional position information and correction information are started between the vehicle V11 and the management device 10. Specifically, the vehicle V11 (the position information calculation unit 51b) receives a GNSS signal (S104) and calculates position information (provisional position information) based on the GNSS signal (S105). The vehicle V11 (the correction information acquisition unit 51c) transmits the calculated provisional position information to the management device 10 (S106).

The management device 10 (the correction information acquisition unit 11b) transmits the provisional position information of the vehicle V11 to the distribution device 201 (S107). At this time, the management device 10 may transmit the provisional position information to the distribution device 201 for the connection ID (N01) associated with the vehicle ID (v0011, see FIG. 6) of the vehicle V11 by the connection ID allocation processing (S103).

The distribution device 201 selects, based on a provisional position, the reference station 202 close to the provisional position out of the plurality of reference stations 202 (S108). The distribution device 201 transmits, for the connection ID (N01), correction information obtained from observation data of the selected reference station 202 to the management device 10 (the correction information acquisition unit 11b) (S109).

The management device 10 (the correction information acquisition unit 11b) transmits the received correction information to the vehicle V11 (S110). At this time, the management device 10 may refer to the ID management table (FIG. 6). For example, when receiving the correction information for the connection ID (N01), the management device 10 may transmit the correction information to a vehicle corresponding to the connection ID (N01) in the ID management table. Unlike this, at the time of communication establishment, a session ID used in communication between the vehicles V1 and V2 and the management device 10 and a session ID used in communication between the management device 10 and the distribution device 201 may be linked in the management device 10. In this case, when transferring the correction information to the vehicle V11, the management device 10 may not refer to the ID management table.

The vehicle V11 (the position information calculation unit 51b) calculates high-accuracy position information using the received correction information (S111). The vehicle V11 (the automatic traveling control unit 51a) controls the driving unit 52, the steering unit 53, and the braking unit 54 based on the high-accuracy position information such that the vehicle V11 travels along a planned route.

The vehicle V11, the management device 10, and the distribution device 201 repeatedly execute the processing in S104 to S111. Therefore, the vehicle V11 executes the calculation and the transmission of the provisional position information and the reception of the correction information at a predetermined period.

Note that the vehicle V11 (the drive information communication unit 51d) may transmit drive information (for example, an output of the sensor unit F and a drive mode) of the vehicle V11 to the management device 10 in parallel to the processing in S104 to S111. For example, in S106, the vehicle V11 may transmit the drive information to the management device together with the provisional position information. The management device 10 (the monitoring unit 11c) may monitor the vehicle V11 based on the drive information. For example, when a drive state of the vehicle V11 does not match a condition specified in advance, the management device 10 may transmit a command, (for example, a stop command) corresponding to the state, to the vehicle V11. A transmission period of the provisional position information and a transmission period of the drive information may be the same or may be different.

The vehicle V21 to which a connection ID is not allocated may transmit drive information and position information by the independent positioning or the differential GPS to the management device 10. The management device 10 (the monitoring unit 11c) may monitor drive of the vehicle V21 based on the drive information and the position information.

The management device 10 ends the connection ID allocation when a predetermined condition is satisfied (S112). For example, the management device 10 periodically refers to the drive schedule table (FIG. 7) explained above and determines whether a period in which the connection ID is allocated to the vehicle V11 has ended. When the period has ended, the management device ends the connection ID allocation. The processing for ending the allocation of the connection ID is explained in detail below.

### [Connection ID Allocation Processing]

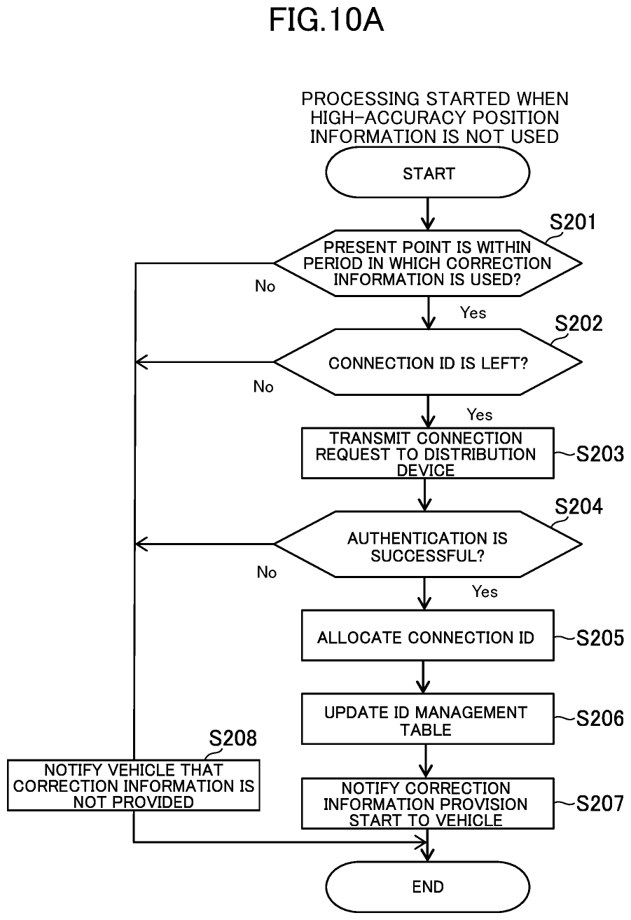

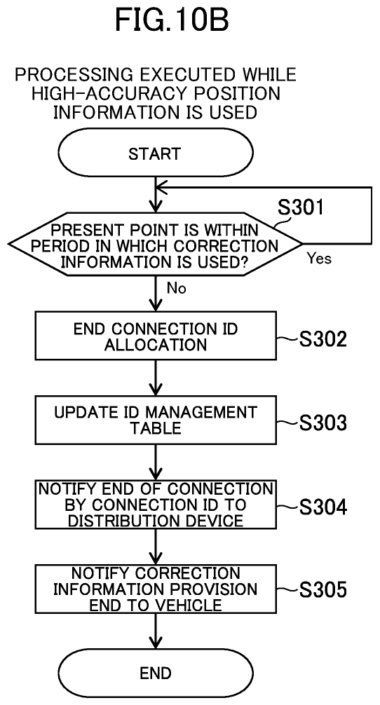

FIG. 10A is a flowchart showing an example of processing executed by the management device 10 in the connection ID allocation processing in S103 shown in FIG. 9. Here, a case in which the vehicle V11 has transmitted an operation start request is explained as an example. The same processing may be executed when an operation start request has been transmitted from another vehicle.

The ID management unit 11a refers to the drive schedule table and determines whether the present point in time corresponds to a period in which correction information is used in control of the vehicle V11 that has transmitted the operation start request (S201). When the present point in time corresponds to the period in which the correction information is used, the ID management unit 11a determines whether a connection ID allocatable to the vehicle V11 is left (S202). The ID management unit 11a refers to, for example, the ID management table and determines whether a connection ID not allocated to the other vehicles is left.

When a connection ID allocatable to the vehicle V11 is left (“Yes” in S202), the ID management unit 11a connects to the distribution device 201 using the connection ID. That is, the ID management unit 11a transmits a connection request to the distribution device 201 using the connection ID (S203). The ID management unit 11a determines whether the authentication in the distribution device 201 is successful, in other words, whether notification of authentication success has been received (S204). When the authentication is successful (“Yes” in S204), the ID management unit 11a allocates the connection ID selected in S202 to the vehicle V11 (S205) and updates the ID management table such that a vehicle ID of the vehicle V11 and the connection ID are associated (S206). Thereafter, the ID management unit 11a notifies a correction information provision start to the vehicle V11 (S207).

On the other hand, when a connection ID allocatable to the vehicle V11 is not left in the determination in S202 (“No” in S202) or when the authentication is unsuccessful in S204 (“No” in S204), the ID management unit 11a may notify the vehicle V11 that the correction information is not provided (S208). When the present point in time does not correspond to the period in which the correction information is used in S201 (“No” in S201), the ID management unit 11a may notify the vehicle V11 that the correction information is not provided (S208). When it is notified that the correction information is not provided, the management device 10 may transmit a stop command or an automatic traveling prohibition command to the vehicle V11. The example of the processing executed by the management device 10 in the connection ID allocation processing is as explained above.

Note that the management device 10 may repeatedly execute the processing in S201 in FIG. 10A at a predetermined period without depending on the operation start request transmitted from the vehicle V11. The management device 10 may refer to the drive schedule table in S201 and, when the present point in time corresponds to the period in which the correction information is used, execute the processing in S202 and subsequent steps.

### [Connection ID Allocation End Processing]

FIG. 10B is a flowchart showing an example of processing executed by the management device 10 in the connection ID allocation end processing in S112 shown in FIG. 9. Here, a case in which the correction information is used in the vehicle V11 is explained.

The ID management unit 11a determines whether the present point in time corresponds to a period in which correction information is used in control of the vehicle V11 (S301). In this determination, the ID management unit 11a may refer to, for example, the drive schedule table. The processing in S301 may be repeatedly executed at a predetermined period in a period in which control using the correction information is executed.

When the present point in time does not correspond to the period in which the correction information is used (“No” in S301), the ID management unit 11a ends the connection ID allocation to the vehicle V11 (S302) and updates the ID management table (S303). That is, the ID management unit 11a cancels the association of the vehicle ID of the vehicle V11 and the connection ID in the ID management table. The ID management unit 11a notifies an end of the connection by the connection ID to the distribution device 201 (S304). The ID management unit 11a may notify an end of provision of the correction information to the vehicle V11 (S305).

The processing shown in FIGS. 10A and 10B is executed for the plurality of vehicles V1 and V2, whereby a connection ID is allocated to the first vehicle V11 in the first period (for example, in the daytime) and the allocation of the connection ID to the first vehicle V11 is cancelled and the same connection ID is allocated to the second vehicle V21 in the second period (for example, in the nighttime). The same applies to the other vehicles V12, V13, V22, and V23. Consequently, it is possible to reduce the number of connection IDs and reduce cost.

### Other Examples of the Table

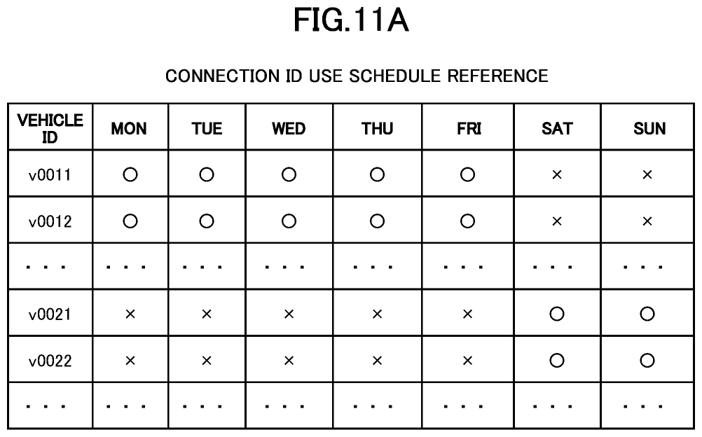

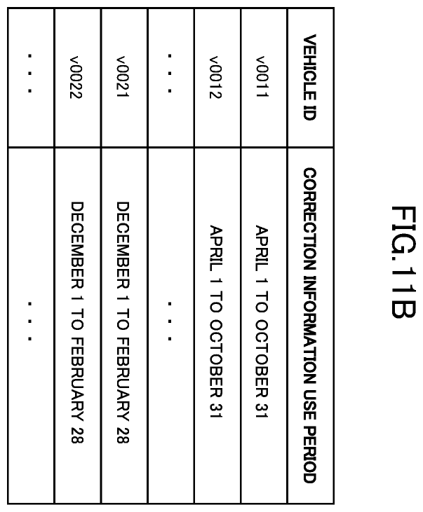

In the drive schedule table shown in FIG. 7, the time period in one day is shown as the period in which the correction information is used. However, the “time period” may be a day of the week in one week. FIG. 11A is a drive schedule table according to such as example. In FIG. 11A, vehicles having vehicle IDs (v0011 and v0012) may be vehicles used to commute to offices and schools in the weekdays. In contrast, vehicles having vehicle IDs (v0021 and v0022) may be, for example, vehicles used in holidays in a tourist spot or a tourist facility.

The time period may be months in one year. FIG. 11B is a drive schedule table according to such an example. In FIG. 11B, the vehicles having the vehicle IDs (v0011 and v0012) are, for example, agricultural vehicles that use correction information in a period of April 1 to October 31. On the other hand, the vehicles having the vehicle IDs (v0021 and v0022) are, for example, snow removing vehicles used in winter.

Note that, in the drive schedule management tables illustrated in FIGS. 7, 11A, 11B, and the like, a connection ID is shared between the vehicles having the vehicle IDs (v0011 and v0012) and the vehicles having the vehicle IDs (v0021 and v0022). On the other hand, a connection ID is not shared between the vehicles having the vehicle IDs (v0011 and v0012). Similarly, a connection ID is not shared between the vehicles having the vehicle IDs (v0021 and v0022).

### [Connection ID Allocation Processing Based on a Drive State]

In the operation system 100, the management device 10 refers to the drive schedule table in allocating the connection IDs. However, the management device 10 may allocate the connection IDs or end the connection ID allocation based on a drive state (including present positions) of the vehicles V1 and V2. In the following explanation, a system that performs such processing is explained. In the following explanation, differences from the operation system 100 explained above are mainly explained. Matters not explained below may be the same as the matters in the example of the operation system 100.

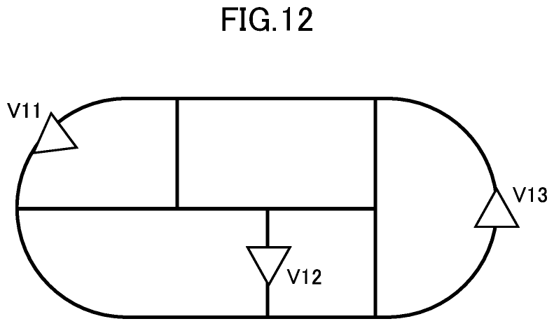

FIG. 12 is a diagram showing an overview of a drive permission area to which such processing is applied. In FIG. 12, solid lines indicate roads on which the vehicles V11, V12, and V13 can travel. In the following explanation, in explanation in which the vehicles V11, V12, and V13 are not distinguished, a reference sign V1 is used for vehicles. Uses of the plurality of vehicles V1 may be the same. For example, the plurality of vehicles V1 are used for transporting users.

A user can transmit a transportation request to the management device 10 through, for example, a portable terminal. The transportation request includes a desired get-on position and a desired get-off position of the user. When receiving the transportation request, the management device 10 selects the vehicle V1 close to the desired get-on position out of standby (stopped) vehicles V1. The management device 10 generates a planned route from the present position of the selected vehicle V1 to the desired get-on position and a planned route from the desired get-on position to the desired get-off position. The planned routes include, for example, continuous position information (coordinates that the vehicle V1 should pass). The management device 10 transmits the planned routes to the selected vehicle V1. The control unit 51 (see FIG. 2) of the vehicle V1 controls the driving unit 52 or the like based on deviation between the present position and the planned routes such that the vehicle V1 travels along the received planned routes.

High-accuracy position information is not required during standby (during a stop) of the vehicle V1. As explained above, the vehicle V1 transmits the drive information (including the position information by the independent positioning) of the vehicle V1 to the management device 10. Therefore, the management device 10 manages the stopped vehicle V1 based on the drive information. On the other hand, when the vehicle V1 is automatically traveling along the planned routes, high-accuracy position information is necessary. Therefore, the management device 10 allocates a connection ID to the vehicle V1 that starts the automatic traveling. When the vehicle V1 stops (stands by) again, the management device 10 ends the connection ID allocation to the vehicle V1.

It is assumed that any one of the plurality of vehicles V1 managed by the management device 10 is stopped. Therefore, the number of connection IDs issued for connection to the distribution device 201 may be smaller than the number of vehicles V1 managed by the management device 10. A connection ID may be allocated to only the automatically traveling vehicles V1 and may not be allocated to the stopped vehicles V1. As a result, one connection ID can be shared in the plurality of vehicles V1.

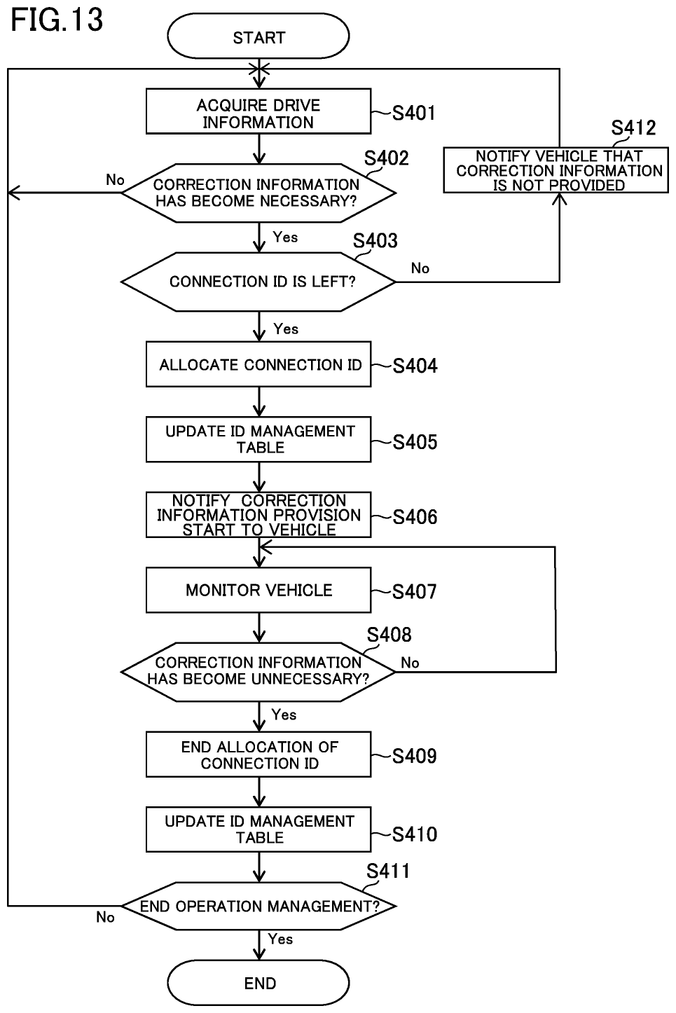

FIG. 13 is a flowchart showing an example of processing executed by the management device 10 in such a system. The processing shown in FIG. 13 is started when the management device receives an operation start request from the vehicle V1. The processing shown in FIG. 13 may be executed for each of the plurality of vehicles V1.

The ID management unit 11a acquires drive information of the vehicle V1 (S401). The drive information includes information indicating whether the vehicle V1 is in a standby state or in a state in which the vehicle V1 is preparing for automatic traveling (for example, a state in which the vehicle V1 is about to start moving toward the desired get-on position). Which state the vehicle V1 is in may be determined based on information that the management device 10 has received from the vehicle V1 or information that the management device 10 has received from a portable terminal of the user. The ID management unit 11a determines, based on the drive information acquired in S401, whether the vehicle V1 has reached a state in which correction information is necessary (S402).

When the correction information is unnecessary (“No” in S402), for example, when the vehicle V1 is in a stop state, the processing of the management device 10 returns to S401. On the other hand, for example, when the vehicle V1 is in the state in which the vehicle V1 is preparing for the automatic traveling (“Yes” in S402), correction information for performing high-accuracy positioning is necessary. In this case, the ID management unit 11a determines whether a connection ID allocatable to the vehicle V1 is left (S403). For example, the ID management unit 11a refers to the ID management table (FIG. 6) and determines whether a connection ID not allocated to the other vehicles V1 is left. When a connection ID allocatable to the vehicle V1 is not left (“No” in S403), the ID management unit 11a may notify the vehicle V1 that correction information is not provided (S412).

On the other hand, when a connection ID allocatable to the vehicle V1 is left, the ID management unit 11a allocates the connection ID to the vehicle V1 (S404) and updates the ID management table (S405). The ID management unit 11a notifies the vehicle V1 that provision of correction information is started (S406). As in the processing shown in FIG. 10A, the ID management unit 11a may connect to the distribution device 201 using the connection ID and receive authentication in the distribution device 201 prior to the processing in S404, S405, and S406. Only when the authentication is successful, the ID management unit 11a may allocate the connection ID to the vehicle V1 (S404) and update the ID management table (S405).

When the connection ID is allocated to the vehicle V1, the vehicle V1, the management device 10, and the distribution device 201 perform the processing indicated by S104 to S111 in FIG. 9. That is, the vehicle V1 transmits provisional position information to the management device 10 at a predetermined period. The management device 10 transmits the provisional position information to the distribution device 201 and receives correction information corresponding to a provisional position as a response from the distribution device 201. The management device 10 transmits the correction information to the vehicle V1. The vehicle V1 performs correction calculation (high-accuracy positioning) based on the correction information. The vehicle V1 starts automatic traveling using information concerning the high-accuracy position.

While the vehicle V1 is performing the automatic traveling, the management device 10 receives drive information from the vehicle V1 and monitors the vehicle V1 (S407). The ID management unit 11a determines whether the correction information has become unnecessary (S408). For example, the ID management unit 11a determines whether the vehicle V1 has reached a stop position (for example, the desired get-off position of the user or a standby position specified in advance).

When the correction information has become unnecessary (“Yes” in S408), the ID management unit 11a ends the allocation of the connection ID (S409) and updates the ID management table (S410). That is, the ID management unit 11a cancels association of the vehicle ID of the vehicle V1 and the connection ID in the ID management table. At this time, as in the processing shown in FIG. 10B, the ID management unit 11a may notify the vehicle V1 that the provision of the correction information ended. The management device 10 repeats the processing in S407 and S408 until the correction information becomes unnecessary.

Thereafter, the management device 10 determines whether an end condition for the operation management for the vehicle V1 is satisfied (S411). The management device 10 determines, for example, whether a period of transportation request reception from the user has ended. When the end condition for the operation management is satisfied (“Yes” in S411), the management device 10 ends the processing. On the other hand, when the end condition for the operation management is not satisfied yet (“No” in S411), the management device 10 returns to S401 and resumes the subsequent processing.

The management device 10 executes the processing shown in FIG. 13, whereby the connection ID (N01) is allocated to the first vehicle V11 in a first period (a period in which the vehicle V11 is automatically travelling and the vehicle V12 is stopped). The allocation of the connection ID (N01) to the first vehicle V11 is cancelled and the connection ID (N01) is allocated to the second vehicle V12 in a second period (a period in which the vehicle V11 is stopped and the vehicle V12 is automatically traveling). The same applies to the other vehicle V13. Consequently, it is possible to efficiently use the connection ID and reduce the number of connection IDs.

Note that the processing illustrated in FIG. 13 may be used in the drive permission area where the route requiring the high-accuracy position information and the route not requiring the high-accuracy position information are specified as illustrated in FIG. 8. In this case, the management device 10 may allocate the connection ID based on the present positions of the vehicles V1 and V2 or end the allocation of the connection ID.

For example, the management device 10 (the ID management unit 11a) acquires the present position of the vehicle V1 in S401 and determines, based on the present position of the vehicle V1, whether the vehicle V1 has reached a state in which correction information is necessary (S402). That is, in S402, the management device 10 determines whether the vehicle V1 has entered the automatic drive route (the route of the broken line in FIG. 8) deviating from the electromagnetic guide wire. When the vehicle V1 has not entered the automatic drive route (“No” in S402), in other words, when the vehicle V1 is present in the route on which the electromagnetic guide wire is laid, the processing of the management device 10 returns to S401. On the other hand, when the vehicle V1 has entered the automatic drive route (“Yes” in S402), the management device 10 (the ID management unit 11a) allocates a connection ID to the vehicle V1. At this time, prior to the allocation of the connection ID, the management device 10 may determine whether a connection ID allocatable to the vehicle V1 is left (S403). The subsequent processing may be the same as the processing explained with reference to FIG. 13.

### [Correction Calculation Executed in the Management Device]

As still another example, the correction calculation based on the correction information, that is, the calculation of the high-accuracy position information may be executed in the management device 10.

For example, when the vehicles V1 and V2 are traveling according to manual operation, necessity of the high-accuracy position information is low in the vehicles V1 and V2. On the other hand, the management device 10 may determine whether the manually operated vehicles V1 and V2 are present in the drive permission area. The determination is desirably performed based on the high-accuracy position information. Therefore, in such a case, the management device 10 may execute the calculation of the high-accuracy position based on the correction information. In this case, the management device 10 may receive information necessary for the correction calculation from the vehicles V1 and V2 in addition to the drive information explained above. The information necessary for the correction calculation is, for example, a carrier wave phase obtained from a GNSS signal received in the vehicles V1 and V2.

In the operation system of the vehicle V1 that travels in the drive permission area illustrated in FIG. 12, the management device 10 may also perform the calculation of the high-accuracy position information. For example, when the user transmits a transportation request to the management device 10 through the portable terminal, the management device 10 may calculate a time required for traveling from the present position of the vehicle V1 to the desired get-on position. In this case, the present position of the vehicle V1 may be the high-accuracy position calculated based on the correction information. In this case as well, the management device 10 may receive information (for example, a carrier wave phase) necessary for the correction calculation from the vehicle V1 in addition to the drive information explained above.

### [Other System Configurations]

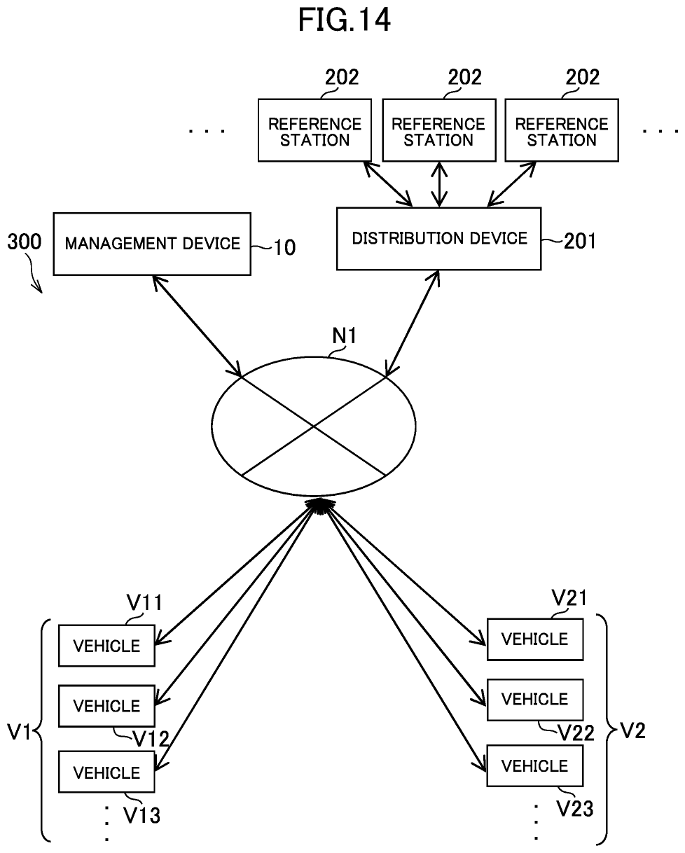

As still another example, the correction information may be transmitted from the distribution device 201 to the vehicles V1 and V2 not through the management device 10. FIG. 14 is a block diagram showing such an operation system 300. In the following explanation, differences from the operation system 100 explained above are mainly explained. Items not explained below may be the same as the items in the example of the operation system 100.

In the operation system 300, the management device 10 is connected to the vehicles V1 and V2 via the network N1. The distribution device 201 is also connected to the vehicles V1 and V2 via the network N1. As in the example shown in FIG. 1, the network N1 may include a WAN including the Internet or a dedicated line and a LAN. These networks include a wired communication network and/or a wireless communication network. When the operation system 300 has a configuration shown in FIG. 14, the control unit 11 of the management device 10 and the control unit 51 of the vehicles V1 and V2 may have functions explained below.

In the operation system 300 as well, the management device includes the ID management unit 11a (see FIG. 5). The ID management unit 11a allocates the connection IDs (N01, N02, N03, and the like) to the plurality of vehicles V1 in the first period (for example, in the daytime) and allocates the connection IDs (N01, N02, N03, and the like) to the plurality of vehicles V2 in the second period (for example, at night). When the connection IDs are allocated to the vehicles V1 and V2, the ID management unit 11a updates the ID management table (FIG. 6).

The ID management unit 11a refers to, for example, the drive schedule table (for example, the table shown in FIG. 7) indicating the period in which the correction information is used in the control of the plurality of vehicles V1 and V2 and allocates the connection IDs to the vehicles V1 and V2. Unlike this, as explained with reference to FIGS. 12 and 13, the ID management unit 11a may allocate the connection IDs to the vehicles V1 and V2 based on the drive state. The ID management unit 11a notifies the allocated connection IDs to the vehicles V1 and V2.

In the operation system 300 as well, the vehicles V1 and V2 include the correction information acquisition unit 51c. When receiving a connection ID from the management device 10, the correction information acquisition unit 51c connects to the distribution device 201 using the connection ID and receives correction information from the distribution device 201. The correction information acquisition unit 51c transmits provisional position information to the distribution device 201 and receives, as a response to the provisional position information, correction information corresponding to a provisional position from the distribution device 201.

In the operation system 300 as well, the ID management unit 11a may determine whether to end the allocation of the connection IDs. When ending the allocation of the connection IDs, the ID management unit 11a may notify the vehicles V1 and V2 to that effect. The correction information acquisition unit 51c of the vehicles V1 and V2 may notify cancellation of connection to the distribution device 201.

Note that, in the operation system 300 as well, the management device 10 may include the monitoring unit 11c. On the other hand, the management device 10 may not include the correction information acquisition unit lib. The vehicles V1 and V2 may include the automatic traveling control unit 51a, the position information calculation unit 51b, and the drive information communication unit 51d.

### SUMMARY

(1) The operation system 100 proposed by the present disclosure includes the ID management unit 11a that allocates, to the plurality of vehicles V1 and V2, a plurality of connection IDs used for connection to the distribution device 201 that distributes correction information. The operation system 100 includes the correction information acquisition unit 11b that transmits provisional position information of the vehicles V1 and V2 to the distribution device 201 and receives, from the distribution device 201, correction information corresponding to a provisional position indicated by the provisional position information. The ID management unit 11a allocates a first connection ID (N01) to the first vehicle V1 in a first period and allocates the first connection ID (N01) to the second vehicle V2 in a second period. In the first period, the correction information acquisition unit 11b connects to the distribution device 201 using the first connection ID (N01) and receives correction information for the first vehicle V1 from the distribution device 201. In the second period, the correction information acquisition unit 11b connects to the distribution device 201 using the first connection ID (N01) and receives correction information for the second vehicle V2 from the distribution device 201. With the operation system 100, since the number of connection IDs can be reduced, it is possible to reduce cost imposed on the operator of the vehicles V1 and V2.

Note that the management device 10 of the operation system 300 illustrated in FIG. 14 includes the ID management unit 11a that allocates connection IDs to the plurality of vehicles V1 and V2. In the operation system 300, in the first period, the correction information acquisition unit 51c of the vehicle V1 connects to the distribution device 201 using the first connection ID (N01). In the second period, the correction information acquisition unit 51c of the vehicle V2 connects to the distribution device 201 using the first connection ID (N01). Therefore, it is possible to reduce the number of connection IDs in the operation system 300.

(2) In (1), a use of the first vehicle V1 and a use of the second vehicle V2 are different. Consequently, a period in which the use of the first vehicle V1 is exerted can be represented as “first period” and a period in which the use of the second vehicle V2 is exerted can be represented as “second period”.

(3) In (1) or (2), a drive area permitted to the first vehicle V1 and a drive area permitted to the second vehicle V2 are different. Time periods in which the vehicles V1 and V2 are used are often different if the drive areas are different. As a result, it is easy to divide the first period and the second period.

(4) In (1) to (3), the ID management unit 11a has the ID management table (FIG. 6) that associates vehicle IDs for identifying the plurality of vehicles V1 and V2 and a plurality of connection IDs. The ID management unit 11a associates a vehicle ID given to the first vehicle V1 with the first connection ID (N01) in the first period and associates a vehicle ID given to the second vehicle V2 with the first connection ID (N01) in the second period. Consequently, it is possible to simplify management of the connection IDs.

(5) In (1) to (4), when a predetermined condition is satisfied, the ID management unit 11a selects, from a plurality of connection IDs, connection IDs allocated to vehicle IDs of the vehicles V1 and V2.

(6) In (1) to (5), the ID management unit 11a refers to the drive schedule table (for example, the tables shown in FIGS. 7, 11A, and 11B) indicating a period in which the correction information is used in control of the plurality of vehicles V1 and V2 and selectively allocates the first connection ID (No 1) to the first vehicle V1 and the second vehicle V2. Consequently, it is possible to systematically allocate the connection ID and avoid shortage of connection IDs.

(7) In (1) to (5), the ID management unit 11a selectively allocates the first connection ID (N01) to the first vehicle V1 and the second vehicle V2 based on drive information of the first vehicle V1 and the second vehicle V2 as explained with reference to FIGS. 12 and 13. Consequently, it is possible to increase flexibility of connection ID allocation.

(8) In (1) to (7), the correction information acquisition unit 11b of the management device 10 transmits the correction information received from the distribution device 201 to the first vehicle V1 in the first period and transmits the correction information received from the distribution device 201 to the second vehicle V2 in the second period. Consequently, it is possible to simplify processing in the vehicles V1 and V2 compared with a system in which the vehicles V1 and V2 directly connect to the distribution device 201 using a connection ID.

(9) In (8), the management device 10 includes the monitoring unit 11c that receives information representing a drive state of the vehicles V1 and V2 from each of the vehicles V1 and V2. Consequently, the vehicles V1 and V2 can share a communication module for monitoring and a communication module for correction information reception. It is possible to achieve a reduction in cost.

(10) In (9), the monitoring unit 11c manages the second vehicle V2 based on the provisional position information of the second vehicle V2 in the first period and manages the first vehicle V1 based on the provisional position information of the first vehicle V1 in the second period. Consequently, even in a period in which connection IDs are not allocated, it is possible to monitor the positions of the vehicles V1 and V2.

(11) In (1) to (10), as explained with reference to FIGS. 12 and 13, the first period is at least a part of a period in which the second vehicle V2 is stopped or a period in which the second vehicle V2 is manually driven, and the second period is at least a part of a period in which the first vehicle V1 is stopped or a period in which the first vehicle V1 is manually driven.

(12) In (1) to (11), the number of the plurality of connection IDs permitted for the connection to the distribution device 201 is smaller than the number of the plurality of vehicles V1 and V2 managed by the operation systems 100 and 300. Consequently, it is possible to reduce cost imposed on the operator of the vehicles V1 and V2.

(13) In (1) to (12), the ID management unit 11a allocates the second connection ID (N02) to the third vehicle V12 in the first period and allocates the second connection ID (N02) to the fourth vehicle V22 in the second period. Consequently, the plurality of vehicles (the first vehicle V11 and the third vehicle V12) operate in the first period and the plurality of vehicles (the second vehicle V21 and the fourth vehicle V22) operate in the second period as well. Therefore, it is possible to improve convenience to a user.

(14) In (1) to (13), the first period and the second period are non-overlapping periods. Consequently, it is possible to simplify connection ID allocation processing.

Although the present invention has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

For example, in the present disclosure, the automatic drive vehicles V1 and V2 are explained as an example of the mobile body. However, the system proposed by the present disclosure may be applied to an unmanned aircraft, a robot, and the like.

What is claimed is:

1. A mobile body operation system that receives, from a distribution device, correction information for calculating high-accuracy position information of a mobile body from provisional position information of the mobile body and operates the mobile body using the high-accuracy position information,
the operation system comprising:
an ID management unit configured to allocate, to a plurality of mobile bodies, connection IDs used for connection to the distribution device; and
a correction information acquisition unit configured to transmit the provisional position information of the mobile bodies to the distribution device and receive, from the distribution device, the correction information corresponding to a provisional position indicated by the provisional position information, wherein
the ID management unit allocates a first connection ID to a first mobile body, which is one of the plurality of mobile bodies, in a first period and allocates the first connection ID to a second mobile body, which is another one of the plurality of mobile bodies, in a second period, and
the correction information acquisition unit connects to the distribution device using the first connection ID and receives the correction information for the first mobile body from the distribution device in the first period and connects to the distribution device using the first connection ID and receives the correction information for the second mobile body from the distribution device in the second period.

2. The mobile body operation system according to claim 1, wherein a use of the first mobile body and a use of the second mobile body are different.

3. The mobile body operation system according to claim 1, wherein a drive area permitted to the first mobile body and a drive area permitted to the second mobile body are different.

4. The mobile body operation system according to claim 1, wherein the ID management unit has ID management information that associates mobile body IDs for identifying the plurality of mobile bodies and a plurality of connection IDs, and the ID management unit associates a first mobile body ID given to the first mobile body with the first connection ID in the first period and associates a second mobile body ID given to the second mobile body with the first connection ID in the second period.

5. The mobile body operation system according to claim 1, wherein, when a predetermined condition is satisfied, the ID management unit selects, from a plurality of connection IDs, connection IDs allocated to the mobile body IDs of the mobile bodies.

6. The mobile body operation system according to claim 1, wherein the ID management unit selectively allocates the first connection ID to the first mobile body and the second mobile body based on drive schedule information indicating a period in which the correction information is used in control of the plurality of mobile bodies.

7. The mobile body operation system according to claim 1, wherein the ID management unit selectively allocates the first connection ID to the first mobile body and the second mobile body based on drive information of the first mobile body and the second mobile body.

8. The mobile body operation system according to claim 1, further comprising a management device including the ID management unit and the correction information acquisition unit, wherein
the correction information acquisition unit transmits the correction information received from the distribution device to the first mobile body in the first period and transmits the correction information received from the distribution device to the second mobile body in the second period.

9. The mobile body operation system according to claim 1, further comprising a management device including the ID management unit and the correction information acquisition unit, wherein
the management device further includes a monitoring unit configured to receive information representing a drive state of the mobile bodies from each of the plurality of mobile bodies.

10. The mobile body operation system according to claim 9, wherein the monitoring unit manages the second mobile body based on the provisional position information of the second mobile body in the first period and manages the first mobile body based on the provisional position information of the first mobile body in the second period.

11. The mobile body operation system according to claim 1, wherein
the first period is at least a part of a period in which the second mobile body is stopped or a period in which the second mobile body is manually driven, and
the second period is at least a part of a period in which the first mobile body is stopped or a period in which the first mobile body is manually driven.

12. The mobile body operation system according to claim 1, wherein a number of the plurality of connection IDs permitted for the connection to the distribution device is smaller than a number of the plurality of mobile bodies managed by the operation system.

13. The mobile body operation system according to claim 1, wherein
the plurality of mobile bodies further include a third mobile body and a fourth mobile body, and
the ID management unit allocates a second connection ID to the third mobile body in the first period and allocates the second connection ID to the fourth mobile body in the second period.

14. The mobile body operation system according to claim 1, wherein the first period and the second period are non-overlapping periods.

15. A mobile body operation method for receiving, from a distribution device, correction information for calculating high-accuracy position information of a mobile body from provisional position information of the mobile body and operating the mobile body using the high-accuracy position information
the method comprising:
an ID management step for allocating, to the mobile body, connection IDs used for connection to the distribution device; and
a correction information acquisition step for transmitting the provisional position information of the mobile bodies to the distribution device and receiving, from the distribution device, the correction information corresponding to a provisional position indicated by the provisional position information, wherein
the ID management step in a first period includes allocating a first connection ID to a first mobile body, and the ID management step in a second period includes allocating the first connection ID to a second mobile body, and
the correction information acquisition step in the first period includes connecting to the distribution device using the first connection ID and receiving the correction information for the first mobile body from the distribution device, and the correction information acquisition step in the second period includes connecting to the distribution device using the first connection ID and receiving the correction information for the second mobile body from the distribution device.

16. A mobile body operation program for causing a computer to function as a system that receives, from a distribution device, correction information for calculating high-accuracy position information of a mobile body from provisional position information of the mobile body and operates the mobile body using the high-accuracy position information,
the operation program causing the computer to function as:
an ID management unit configured to allocate, to a plurality of mobile bodies, connection IDs used for connection to the distribution device; and
a correction information acquisition unit configured to transmit the provisional position information of the mobile bodies to the distribution device and receive, from the distribution device, the correction information corresponding to a provisional position indicated by the provisional position information, wherein
the ID management unit allocates a first connection ID to a first mobile body in a first period and allocates the first connection ID to a second mobile body in a second period,
the correction information acquisition unit connects to the distribution device using the first connection ID and receives the correction information for the first mobile body from the distribution device in the first period and connects to the distribution device using the first connection ID and receives the correction information for the second mobile body from the distribution device in the second period.
